(19) United States
(12) Patent Application Publication
(10) Pub. No.: US 2016/0352113 A1
(43) Pub. Date: Dec. 1, 2016

(54) ELECTRIC VEHICLE CHARGING STATION

(71) Applicant: GM GLOBAL TECHNOLOGY OPERATIONS LLC, Detroit, MI (US)

(72) Inventors: Xiang Zhao, Novi, MI (US); Susan M. Smyth, Rochester Hills, MI (US)

(73) Assignee: GM GLOBAL TECHNOLOGY OPERATIONS LLC, Detroit, MI (US)

(21) Appl. No.: 15/092,243

(22) Filed: Apr. 6, 2016

Related U.S. Application Data
(60) Provisional application No. 62/168,047, filed on May 29, 2015.
(60) Provisional application No. 62/168,042, filed on May 29, 2015.

(51) Int. Cl. H02J 7/00; B25J 5/02; B25J 11/00; B60L 11/18

(52) U.S. Cl. CPC H02J 7/0027; B60L 11/1827; B60L 11/1838; B60L 11/1816; B25J 5/02; B25J 11/008

(57) ABSTRACT

A multi-user electric vehicle charging station is described, and includes a movable charging apparatus that is disposed to service a plurality of parking spaces and a controller that operatively connects to the movable charging apparatus. A human/machine interface device communicates with the controller and includes an interface device including user-selectable states including a user identification, identification of a specific one of the parking spaces and an expected departure time associated with a vehicle parked in the specific one of the parking spaces.

### CROSS-REFERENCE TO RELATED APPLICATIONS

This application claims the benefit of U.S. Provisional Patent Application No. 62/168,047 filed on May 29, 2015, the disclosure of which is hereby incorporated by reference.

This application claims the benefit of U.S. Provisional Patent Application No. 62/168,042 filed on May 29, 2015, the disclosure of which is hereby incorporated by reference.

### TECHNICAL FIELD

The present disclosure relates to operating an electric vehicle charging station for a plurality of electric vehicles.

### BACKGROUND

Various types of automotive vehicles, such as electric vehicles (EVs), extended-range electric vehicles (EREVs), and hybrid electric vehicles (HEVs) are equipped with energy storage systems that require periodic charging. The energy storage system may be charged by connecting to a power source, such as an AC supply line.

### SUMMARY

A multi-user electric vehicle charging station is described, and includes a movable charging apparatus that is disposed to service a plurality of parking spaces and a controller that operatively connects to the movable charging apparatus. A human/machine interface device communicates with the controller and includes an interface device including user-selectable states including a user identification, identification of a specific one of the parking spaces and an expected departure time associated with a vehicle parked in the specific one of the parking spaces.

Furthermore, a movable charging apparatus of an electric vehicle charging station that is disposed to service a plurality of parking spaces is described. A method for controlling the movable charging apparatus executes upon entry of a vehicle into one of the vehicle parking spaces accompanied with a charging request for a vehicle battery. The method includes determining, for each of a plurality of vehicles parked in the parking spaces, a vehicle arrival time, a remaining power level for the vehicle battery, a total electric power capacity of the vehicle battery, a period of time required to achieve a target charge level for the vehicle battery, an average parking time, an expected departure time, and credit points. A controller determines a preferred charging sequence for the plurality of vehicles parked in the parking spaces based upon their corresponding vehicle arrival times, remaining power levels for the vehicle batteries, the total electric power capacities of the vehicle batteries, the periods of time required to achieve the target charge level for the vehicle batteries, the average parking times, the expected departure times, and the credit points. The vehicles parked in the parking spaces are sequentially charged employing the movable charging apparatus based upon the preferred charging sequence.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic plan view of an electric vehicle charging station employing a ground mounted movable charging apparatus, in accordance with the disclosure;

FIG. 2 is a schematic plan view of an electric vehicle charging station employing an overhead mounted movable charging apparatus; in accordance with the disclosure;

FIG. 3 is a schematic side view of a ground mounted movable charging apparatus, in accordance with the disclosure;

FIG. 4 is a schematic side view of an overhead mounted movable charging apparatus, in accordance with the disclosure;

FIG. 5 is a schematic, system-level flow diagram of a charging algorithm, in accordance with the disclosure;

FIG. 6 is a schematic flow diagram of a method of detecting the presence and identity of an electric vehicle requiring a recharge, in accordance with the disclosure;

FIG. 7 is a schematic flow diagram of a method of moving a charging apparatus and end effector to a vehicle requiring charging, in accordance with the disclosure;

FIG. 8 is a schematic flow diagram of a method of coupling an end effector with a charging receptacle of a vehicle, including opening a door covering the receptacle if needed, in accordance with the disclosure;

FIG. 9 schematically shows a front screen of a human/machine interface device for capturing user information including charging requests from a user who parked a vehicle in a parking space serviced by the movable charging apparatus, in accordance with the disclosure;

FIG. 10 schematically shows one embodiment of a mobile device that communicates with a charging controller for capturing user information including charging requests from a user who parked a vehicle in one of the parking spaces serviced by the movable charging apparatus, in accordance with the disclosure; and

FIG. 11 is a schematic plan view of another embodiment of an electric vehicle charging station employing a ground mounted movable charging apparatus, in accordance with the disclosure.

### DETAILED DESCRIPTION

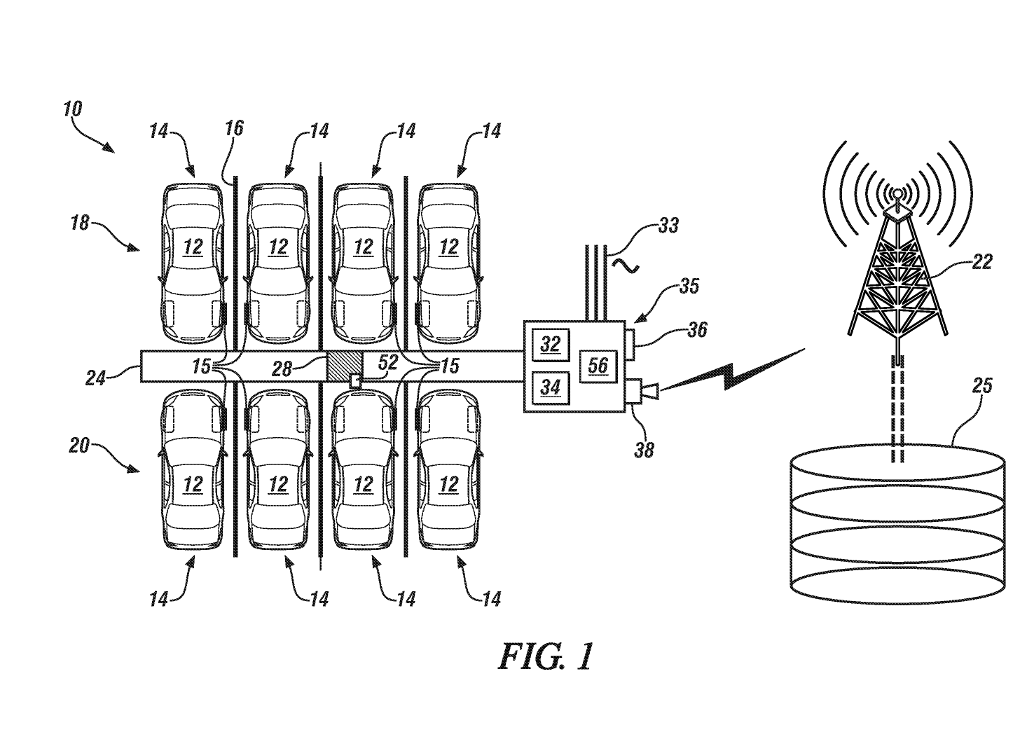

Referring to the drawings, wherein like reference numerals are used to identify like or identical components in the various views, FIG. 1 schematically illustrates one embodiment of an electric vehicle charging station 10 that is capable of servicing a plurality of parking spaces 14 for charging a primary energy storage device of each of a plurality of electric vehicles 12 that are parked therein, e.g., at a public or private parking lot that includes the plurality of parking spaces 14. The electric vehicle charging station 10 described herein is provided for purposes of illustration; the concepts described herein may be employed on various configurations of electric vehicle charging stations that provide charging service for a plurality of parking spaces 14 for charging a primary energy storage device for a plurality of electric vehicles 12. As used herein, an electric vehicle 12 may encompass any vehicle that uses an electric motor as a source of power for vehicle propulsion. While an automobile will be used as the exemplary vehicle for the purpose of this description, other vehicles may similarly be used. Some examples of electric vehicles include, but are not limited to, electric-only electric vehicles (EVs), plug-in hybrid electric vehicles (PHEVs), extended range electric vehicles (EREVs). These vehicles may include passenger cars, cross-over vehicles, sport-utility vehicles, recreational vehicles, trucks, buses, commercial vehicles, etc.

The electric vehicle 12 may operate by expending electrical energy from an energy storage device, such as a vehicle battery, to power an electric motor during a period of propulsion. After a prolonged period of energy depletion, the vehicle battery may require re-charging before continued propulsion may resume. Such re-charging may occur by coupling the vehicle battery to a source of electrical power either directly, or through one or more intermediate components.

In general, the electric vehicle charging station 10 may be a stationary apparatus that may be disposed in a parking lot or other vehicle storage area that includes a plurality of parking spaces 14, including, e.g., a parking garage, a valet parking area, and a fleet vehicle storage area, etc. As used herein, a parking space 14 is an area that is intended to receive a vehicle for a period of time. Parking spaces 14 may be delineated by visual indicators 16 provided on the ground (e.g., as with a parking lot), or by physical objects (as occurs at a conventional gas station where a plurality of gasoline pumps delineate the respective parking spaces that are intended to receive a vehicle for refueling).

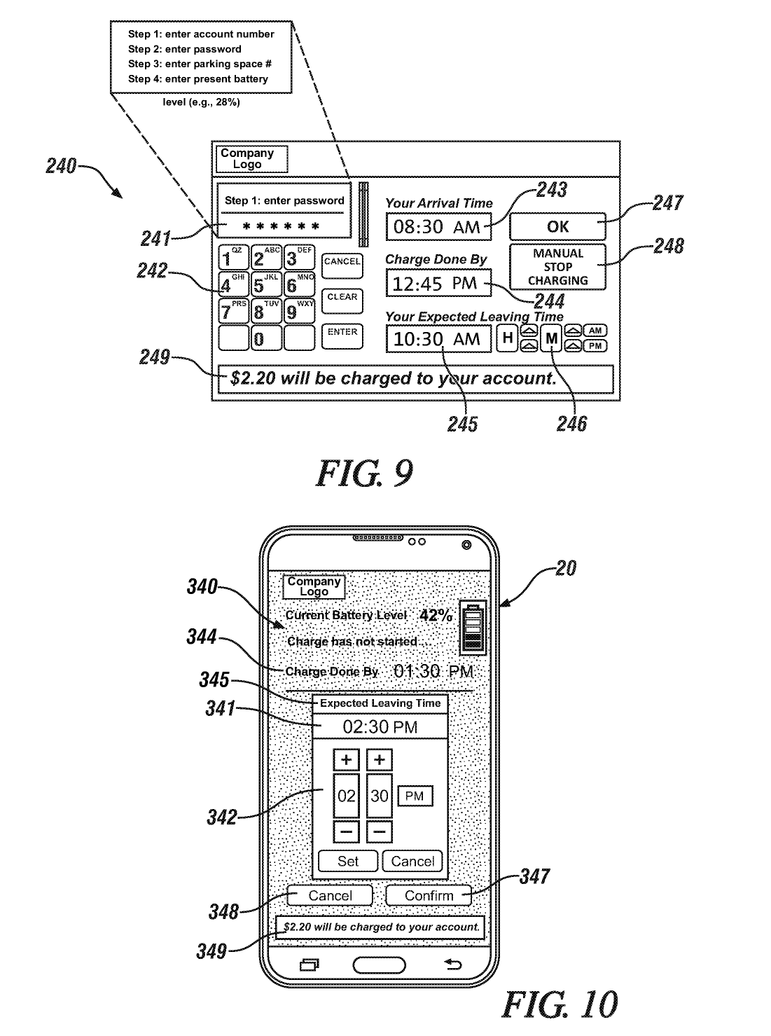

FIG. 1 illustrates one embodiment of a recharging area that includes eight parking spaces 14, organized into two rows 18, 20 of four spaces 14 each. The charging station 10 may include a respective track 24 that extends across a plurality of the parking spaces 14 (e.g., along each row 18, 20), and allows a movable charging apparatus 28 to access each vehicle 12 to facilitate selective recharging of the vehicle's battery. In general, the track 24 may have two general configurations in the form of either a ground-level track or an overhead track. Regardless of the specific configuration, the track 24 may support its movable charging apparatus 28 and allow the charging apparatus 28 to translate along the track 24 to gain access to charging receptacles 15 disposed on each of the vehicles 12 in the station 10. The charging apparatus 28 may be electrically and communicatively coupled with an automatic charging station 35 including a power supply circuit 32, a charging controller 34, a robotic controller 56 and a human/machine interface device 36, e.g., a graphic user interface or touchpad. Embodiments of a graphic user interface are shown with reference to FIGS. 9 and 10. The human/machine interface device 36 is a single device that services all of the parking spaces 14 accessible to and serviced by the movable charging apparatus 28 in this embodiment. The human/machine interface device 36 communicates user inputs in the form of charging requests to the charging controller 34. The automatic charging station 35 may further include a communication device 38 that is capable of communicating with a remote server 25. In one embodiment, the communication device 38 is a wireless communications device that communicates with the remote server 25 via a communications tower 22. Alternatively, communications between the automatic charging station 35 and the remote server 25 may occur via an Internet-based network or another suitable communications mechanism. The communication device 38 may include one or more wireless transceivers for performing wireless communication and/or one or more communication ports for performing wired communication.

The remote server 25 includes a processing device, a communication device, and memory device that preferably includes a file related to the electric vehicle charging station 10. The processing device of the remote server 25 may include memory, e.g., read only memory (ROM) and random access memory (RAM), storing processor-executable instructions and one or more processors that execute the processor-executable instructions. In embodiments including two or more processors, the processors can operate in a parallel or distributed manner. The communication device of the remote server 25 is a device that allows communication with another device, e.g., a mobile device. The communication device can include one or more wireless transceivers for performing wireless communication and/or one or more communication ports for performing wired communication.

In one embodiment, the movable charging apparatus 28 may include a base that is slidably coupled to the track 24 and an end effector 52 that is mechanically coupled to the base. The end effector 52 may be configured to electrically couple with one of the vehicles 12 disposed within an adjacent parking space 14. The end effector 52 may be any suitable charge coupler for connecting with an on-vehicle charging receptacle 15. In one embodiment, the end effector 52 and charging receptacle 15 are configured to comply with an industry-recommended practice, e.g., SAE J1772 or related variants that defines a conductive charging system architecture that includes recommended practices for operational, functional, dimensional, mating and communication requirements for coupling to a vehicle to effect electrical charging of an on-vehicle battery. Preferably, the movable charging apparatus 28 and end effector 52 are configured to effect fast or rapid charging of an on-vehicle battery, which may include being capable of electrically charging an on-vehicle battery to effect a full charge or a target charge level in less than thirty minutes. The end effector 52 may be in mechanical communication with the base through a plurality of rigid arm members that may be capable of articulating and/or translating relative to each other. In other configurations, the end effector 52 may be mechanically coupled to the base through a flexible electrical cable.

In a basic implementation of the present charging station 10, the end effector 52 may manually positioned/manipulated into electrical communication with a vehicle 12 by a user. For example, if a user wishes to charge their vehicle 12, they may slide the charging apparatus 28 to an area proximate to their vehicle 12, and manually place the end effector 52 into electrical communication with the charging receptacle 15 disposed on their vehicle. In another configuration, the vehicle charging station 10 may be fully automated, and may be configured to robotically charge a user's vehicle 12 with minimal interaction from the user. In one configuration, the user's involvement in the charging process may be limited to providing an indication of a desired charge and/or enabling the charging apparatus 28 to gain access to the charging receptacle 15.

The charging controller 34 executes one or more control routines to determine a preferred charging sequence for all the vehicles 12 that are parked in the parking spaces 14 serviced by the electric vehicle charging station 10. The preferred charging sequence may be in the form of a charging queue that identifies each of the vehicles 12 and its place in the queue. Determining the preferred charging sequence for all the vehicles that are parked in the parking spaces 14 serviced by the electric vehicle charging station 10 may be determined by any suitable queuing and priority determination scheme. The charging controller 34 controls the charging apparatus 28 to recharge a battery of one or more of the parked electric vehicles 12.

The charging controller 34 may automatically execute one or more charging control algorithms to implement a charging procedure at one of the vehicles 12. The charging controller 34 may communicate with the robotic controller 56 to control position of the charging apparatus 28 and the end effector 52 to automatically execute one or more motion control algorithms via one or more joint motors to initiate charging of one of the vehicles 12. Each control/processing routine may be embodied as software or firmware, and may either be stored locally on the respective controller 56, 34, or may be readily accessible by the controller 56, 34 from the remote server 25.

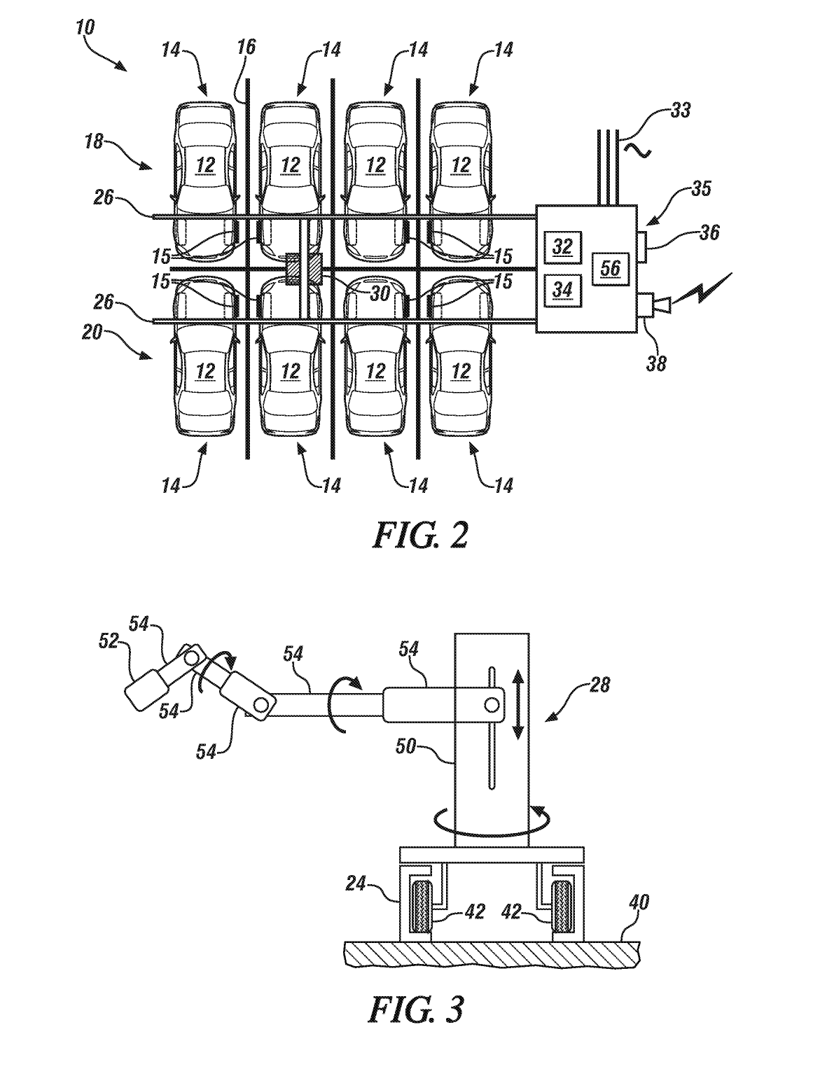

FIGS. 1 and 2 each illustrate a recharging area that includes eight parking spaces 14, organized into two rows 18, 20 of four spaces 14. Each charging station 10 may include a respective track 24, 26 that extends across a plurality of the parking spaces 14 (e.g., along each row 18, 20), and allows a movable charging apparatus 28, 30 to access each of the vehicles 12 to facilitate selective recharging of the vehicle's battery.

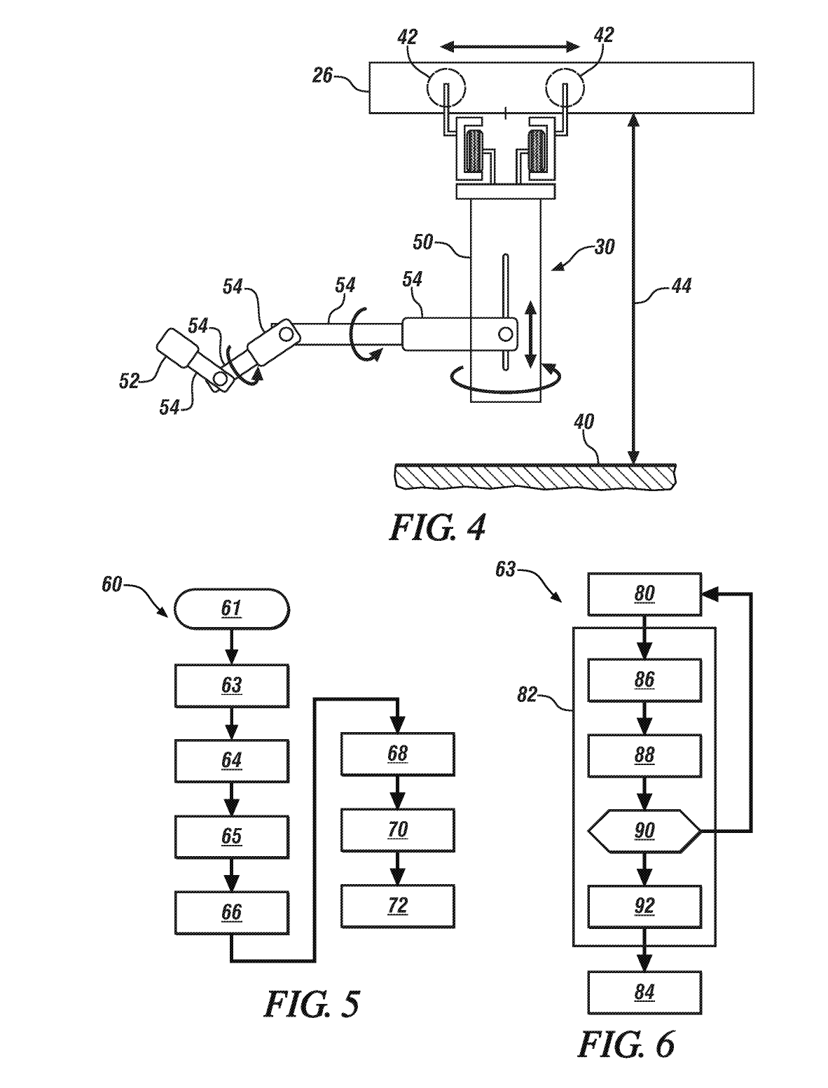

The track 24, 26 may be one of two configurations, namely a ground-level track 24 as shown in FIGS. 1 and 3, and an overhead track 26 as shown in FIGS. 2 and 4. Regardless of the specific configuration, each track 24, 26 may support its respective movable charging apparatus 28, 30, and allow the charging apparatus 28, 30 to translate along the track 24, 26 to access charging receptacles 15 disposed on each of the vehicles 12 in the station 10. As will be described in greater detail below, the charging apparatus 28, 30 may be coupled with an automatic charging station 35 including a power supply circuit 32, a charging controller 34, and a human/machine interface device 36, e.g., a graphic user interface or touchpad, to control the charging apparatus 28, 30 to recharge a battery of one or more of the parked electric vehicles 12.

FIGS. 3 and 4 illustrate schematic examples of a ground-level track 24 and overhead track 26, respectively, that are used to support the respective movable charging apparatus 28, 30. As shown in FIG. 3, the ground-level track 24 may be disposed on the ground 40, or substantially on the ground 40 such that the movable charging apparatus 28 is disposed above the track 24. The movable charging apparatus 28 may translate along the track 24, for example, using one or more wheels 42 that are configured to ride on or within a portion of the track 24. The ground-level track 24 may permit the charging apparatus 28 to physically translate between the respective vehicles 12, though may require a minimum clearance between the rows 18, 20 that is commensurate with the width of the track 24/charging apparatus 28.

Referring to FIG. 4, the overhead track 26 may be disposed a distance 44 above the ground 40 that is, for example, between 5 and 12 feet. The charging apparatus 30 may hang from the track 26 such that the charging apparatus 30 is located between the track 26 and the ground 40. While the overhead track 26 may be beneficial from a land-use perspective by allowing the rows 18, 20 to be spaced closer together, the ground-level track 24 may require less infrastructure to implement. In one configuration the overhead track 26 may be hung from a plurality of existing light poles within the parking lot 10.

Regardless of the form of the track 24, 26, the movable charging apparatus 28, 30 may include a base 50 that is slidably coupled to the track 26, and an end effector 52 that is mechanically coupled to the base 50. The end effector 52 may be configured to electrically couple with one of the vehicles 12 disposed within an adjacent parking space 14. The end effector 52 may be any suitable charge coupler for connecting with an on-vehicle charging receptacle 15. In one embodiment, the end effector 52 is configured to comply with an industry-recommended practice, e.g., SAE J1772 or related variants that defines a conductive charging system architecture that includes recommended practices for operational, functional, dimensional, mating and communication requirements for coupling to a vehicle to effect electrical charging of an on-vehicle battery. Preferably, the movable charging apparatus 28, 30 and end effector 52 are configured to effect fast or rapid charging of an on-vehicle battery, which may include being capable of electrically charging an on-vehicle battery to effect a full charge or a target charge level in less than thirty minutes.

With continued reference to FIGS. 3 and 4, in one configuration, the end effector 52 may be in mechanical communication with the base 50 through a plurality of rigid arm members 54 that may be capable of articulating and/or translating relative to each other. In other configurations, however, the end effector 52 may be mechanically coupled to the base 50 through a flexible electrical cable.

In one implementation of the present charging station 10, the end effector 52 may manually positioned/manipulated into electrical communication with a vehicle 12 by a user. For example, if a user wishes to charge his/her vehicle 12, they may slide the charging apparatus 28, 30 to an area proximate to their vehicle 12, and manually place the end effector 52 into electrical communication with a suitable charging receptacle 15 disposed on their vehicle, such as where the charging receptacle 15 refers to an electrical connection/plug disposed on the vehicle and in electrical communication with an electrical storage device, such as a battery. In this implementation, any joints provided between the arm members 54 may be purely passive and may allow a user to freely manipulate the end effector 52.

In another configuration, the vehicle charging station 10 may be fully automated, and may be configured to robotically charge a user's vehicle 12 with minimal interaction from the user. In one configuration, the user's involvement in the charging process may be limited to providing an indication of a desired charge and/or enabling the charging apparatus 28, 30 to gain access to the charging receptacle 15.

In a robotic implementation, the position and orientation of the end effector 52 may be robotically controlled in 5 or more degrees of freedom (for example, 3 translation degrees, and 2 or more rotational degrees) through the selective actuation of one or more joint actuators disposed between one or more arm members 54. The joint actuators and resultant motion of the end effector 52 may be controlled by a robotic controller 56, such as schematically shown in FIGS. 1 and 2. While the following description relates to a robotic implementation of the present system 10, certain aspects may similarly be used in a manual version of the system 10, particularly those that are implemented by the charging controller 34.

Each of the robotic controller 56 and charging controller 34 may be embodied as one or multiple digital computers or data processing devices, having one or more microcontrollers or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, and/or signal conditioning and buffering electronics. The robotic controller 56 and charging controller 34 may be embodied as distinct software modules within a single computing device, or may be embodied as physically separate hardware modules.

The charging controller 34 may automatically perform one or more charging control algorithms to execute a charging procedure if the controller 34 determines that a vehicle has requested an electric charge. In a similar manner, the robotic controller 56 may be configured to automatically perform one or more motion control algorithms to control the resultant motion of the end effector 52 via the one or more joint motors to effectuate the charging process. Each control/processing routine may be embodied as software or firmware, and may either be stored locally on the respective controller 56, 34, or may be readily accessible by the controller 56, 34.

FIG. 5 schematically illustrates a system-level flow diagram of a charging routine 60 that may be executed by a charging controller to control operation of an electric vehicle charging station to electrically charge energy storage devices of a plurality of electric vehicles, e.g., the charging controller 34 associated with the electric vehicle charging station 10 described with reference to FIGS. 1-4. Table 1 is provided as a key wherein the numerically labeled blocks and the corresponding functions are set forth as follows, corresponding to the charging routine 60.

TABLE 1

| BLOCK | BLOCK CONTENTS |
|---|---|
| 61 | Initiate upon detecting arrival of vehicle |
| | requesting charging |
| 63 | Determine information related to newly |
| | arrived vehicle |
| 64 | Determine preferred charging sequence of |
| | all vehicles |
| 65 | Identify next vehicle in charging queue |
| 66 | Move charger to identified vehicle |
| 68 | Couple charger to identified vehicle |
| 70 | Execute charging |
| 72 | Disconnect charger from vehicle |

Execution of the charging routine 60 preferably initiates upon detecting arrival of a vehicle 12 in one of the parking spaces 14 serviced by the electric vehicle charging station 10 at step 61. In addition, the charging routine 60 may initiate upon detecting departure of a vehicle 12 from one of the parking spaces 14 serviced by the electric vehicle charging station 10 when the departing vehicle 12 has left without charging its on-vehicle battery.

The charging controller 34 determines information related to a newly-arrived vehicle 12 at step 63. As further explained with reference to FIG. 6, step 63 may include three general aspects: presence detection and verification at step 80, charge determination at step 82, and user identification at step 84. Step 63 may initiate at step 80 when the charging controller 34 receives a sensory indication that a vehicle 12 has entered a parking space 14. The sensory indication may be from, for example, a pressure mat embedded in the ground of the parking space 14, from an ultrasound, laser, or radar proximity detector, from a visual camera associated with the charging station 10, or from an action performed by a user, e.g., push a button to indicate a charging request.

Once the presence of a vehicle 12 is detected at step 80, the charging controller 34 may initiate communication with the vehicle 12 at step 86. The communication may be via a data link, such as for example, a satellite-based communication link, a wireless link according to an IEEE 802.11 or Bluetooth standard, a point-to-point data link, an RFID data link, or another transponder-based data link. Once a communication link is established at step 86, the charging controller 34 may read vehicle battery information and state of charge at step 88, compare the state of charge to a threshold at step 90, and indicate a charging request at step 92 if the state of charge is below a threshold. In an alternate embodiment, a user may manually request charging through some user-controlled input to the system 10, including smartphone input, or keypad input at the human/machine interface 36.

Following the detection of a vehicle at 80, and the determination that charging is being requested at step 82, the charge controller 34 may determine the identification of a user that is associated with, is driving, or owns the vehicle 12 at step 84. The user identification step 84 may allow the electric vehicle charging station 10 to account for individual energy consumption, and generate an invoice where applicable. The user identification step 84 may include wirelessly receiving a user identifier via the established communication link, or by manually prompting the user to enter billing information, such as a personal identification number, or a credit card number. Once the user is properly identified, the pertinent information for the vehicle 12 is captured by the charge controller 34.

The charge controller 34 determines a preferred charging sequence for all the vehicles 12 that are parked in the parking spaces 14 serviced by the electric vehicle charging station 10, including the newly arrived vehicle 12 that has been identified at step 64. The preferred charging sequence may be in the form of a charging queue that identifies each of the vehicles 12 and its place in the queue. Determining the preferred charging sequence for all the vehicles that are parked in the parking spaces 14 serviced by the electric vehicle charging station 10 includes as follows.

States for input parameters are determined for each of the vehicles 12 that are parked in the parking spaces 14, including a vehicle arrival time, a remaining power level for the vehicle battery, a total electric power capacity of the vehicle battery, a period of time required to achieve a target charge level for the vehicle battery, an average parking time, an expected departure time, and credit points, if any. The remaining power level for the vehicle battery may be in any suitable value, and is often reported as a percentage of battery state of charge (SOC). The total electric power capacity of the vehicle battery may be expressed in terms of kilowatt-hours. The period of time required to achieve a target charge level for the vehicle battery may be calculated or otherwise determined, with the target charge level expressed in terms of a full charge or a target charge level, e.g., 85% SOC. The average parking time may be calculated based upon historical data for each vehicle. The expected departure time may be based upon historical data or user input. The credit points may be defined by a service provider, and may relate to fee payments and other factors.

A preferred charging sequence for the plurality of vehicles parked in the parking spaces may be determined based upon their corresponding vehicle arrival times, remaining power levels for the vehicle batteries, the total electric power capacities of the vehicle batteries, the periods of time required to achieve the target charge level for the vehicle batteries, the average parking times, the expected departure times, and the credit points, as follows, wherein V₁, V₂, V₃, . . . , Vₙ represents the preferred vehicle charging sequence, and

{V₁,V₂,V₃, . . . ,Vₙ}=ƒ([T₀_{_}ᵢ,i=1,2,3, . . . n)],

[P₀_{_}ᵢ,i=1,2,3, . . . n)],

[BTC₀_{_}ᵢ,i=1,2,3, . . . n)],

[CT₀_{_}ᵢ,i=1,2,3, . . . n)],

[PT_{avg}_{_}ᵢ,i=1,2,3, . . . n)],

[CR_{—i},i=1,2,3, . . . n)],

[T₁_{_}ᵢ,i=1,2,3, . . . n)])

wherein the input variables are defined as follows:

Input Variables

| Name | Description | Unit | Data Source |
|---|---|---|---|
| Pₒ | Remaning power level of EV battery | % | Automatically obtained via system-to-vehicle communication |
| BTCₒ | Total capacity of EV battery | kWh | Automatically obtained from system databse (via vehicle make/model/model year) |
| CTₒ | Time needed for a full (or 85%) charge | Minutes | Automatically obtained from system databse (via vehicle make/model/model year) |
| Tₒ | Vehicles' arriving time | | Automatically recorded by system |
| PT_{avg} | Vehicles' parking time: Average (in hrs) | Hour | Automatically calculated from the parking history stored in system database |
| PTₘᵢₙ | Vehicles' parking time: Minimum (in hrs) | Hour | Automatically calculated from the parking history stored in system database |
| PTₘₐₓ | Vehicles' parking time: Miximum (in hrs) | Hour | Automatically calculated from the parking history stored in system database |
| T₂ | Vehicles' leaving time: Expected | Hour | user input |
| CR | Vehicles' credit points | | Automatically calculated and recorded by system |
| | (negative number means “Service Fee owed”) | | |

The term i represents vehicle number and n represents the total number vehicles. The function ƒ( . . . ) may be in the form of a time and power analysis of the elements that achieves charging of all of the vehicles to a target charge level prior to their expected leaving or departure times. Each of the parameters related to vehicle arrival time, remaining power level for the vehicle battery, total electric power capacity of the vehicle battery, period of time required to achieve a target charge level for the vehicle battery, average parking time, expected departure time, and credit points may be given equivalent weight or preferential weighting.

The charging routine 60 executes in response to arrival of another vehicle, or in response to a user-initiated “cut in line” request or a user-initiated “extending parking” offer. One of the parked vehicles 12 may not get a full charge in one time (without break) depending on status of other vehicles 12, include remaining battery power, time needed for a full charge, and departure time.

Preferably, the charging routine 60 employs the electric vehicle charging station 10 to sequentially charge the plurality of vehicles 12 based upon the preferred charging sequence. The preferred charging sequence is based on the arrival times, the remaining power levels, and the vehicles' normal parking times (via their parking history) and expected departure times. If a user sends the system a “cut in line” request or an “extending parking” offer by providing an expected departure time, the charging routine 60 re-executes and may make an adjustment to the sequence.

For the “cut in line” request, there may be a fee charged to the user, with an amount dependent on the length of the expected parking time. For the “extending parking” offer, there may be a credit given to the user. By way of example a credit point may be related to charging time, with “cut in line” being charged an extra service fee equivalent to a full charge service fee, and an “extending parking” being credited a service credit equivalent to a full charge service fee.

The charging routine 60 sequentially charges the plurality of vehicles parked in the parking spaces employing the movable charging apparatus based upon the preferred charging sequence. When the preferred charging sequence has been determined, the next vehicle in the charging queue is identified (65), the charging apparatus 28, 30 may be moved to the identified next vehicle (66) and the end effector 52 may be electrically coupled to its charging receptacle 15 (68). In one embodiment, the controller 34 may instruct the robotic controller 56 to move the charging apparatus 28, 30 with end effector 52 to the vehicle requiring charging (66) and couple the end effector 52 to the charging receptacle 15 (68).

Alternatively, a charging station operator may slide the charging apparatus 28, 30 to an area proximate to the next vehicle, and manually couple the end effector 52 with the charging receptacle 15 disposed on the next vehicle. When the system includes a charging station operator that manually couples the end effector 52 with the charging receptacle 15, the charging station operator preferably has access to a human/machine interface device, e.g., a hand-held device that shows the charging queue including order of charging. The operator initiates operation, e.g., by pressing a “Go” button on the hand-held device, and the charging apparatus 28, 30 automatically moves to an appropriate position proximate to the vehicle to be charged. The operator may manually grab the charging apparatus end effector 52 and insert it to the vehicle charging receptacle 15 for charging. When charging has completed, the information will be sent to the hand-held device to notify the operator which vehicle is next in the queue.

Once the end effector 52 is coupled to the charging receptacle 15, the charging controller 34 may charge the vehicle at step 70 until the vehicle reports a state of charge (SOC) above a particular threshold. Finally, at step 72, the charging controller 34 may instruct the robotic controller 56 to disconnect from the vehicle 12 and return to a home position before beginning a subsequent charging procedure.

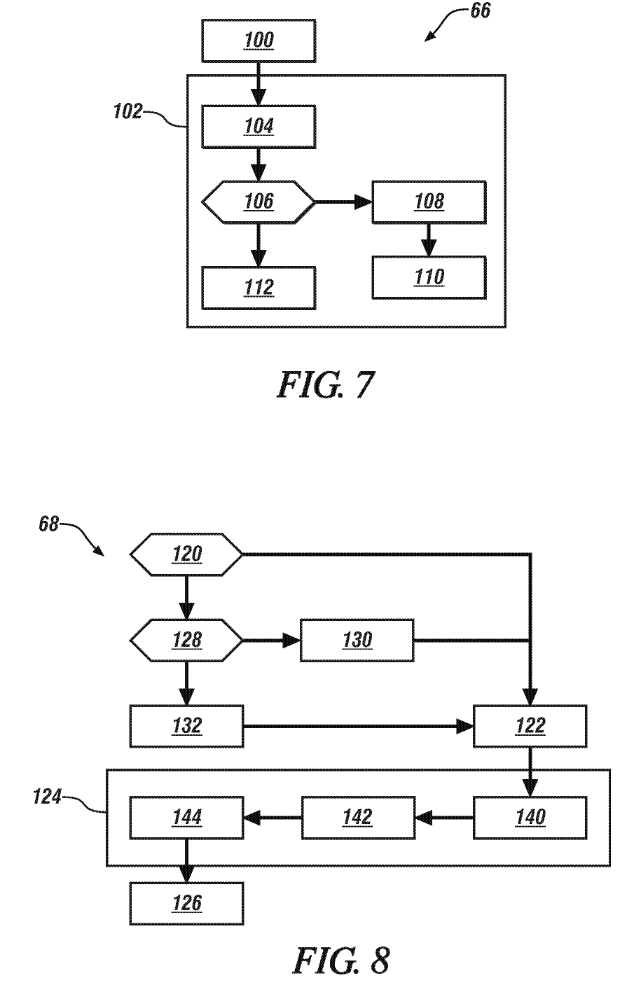

FIGS. 6-8 provide additional detail on various embodiments of steps 63-68. As shown with reference to FIG. 7, step 66 may involve two general aspects: translating the movable charging apparatus 28, 30 to an appropriate location along the track 24, 26 (at 100); and positioning the end effector 52 proximate to the charging receptacle 15 on the vehicle 12 (at 102).

Referring to FIG. 7, and with continued reference to FIGS. 1-4, to position the charging apparatus 28, 30 to an appropriate location along the track 24, 26 (100), the robotic controller may actuate one or more drive wheels that may allow the charging apparatus 28, 30 to self-propel along the track 24, 26. In another embodiment, the charging apparatus 28, 30 may be coupled with a drive chain that may extend the length of the track 24, 26 and pull the charging apparatus 28, 30 to the appropriate position at the urging of a stationary drive motor. As further illustrated in FIGS. 2 and 4, in another embodiment, the charging apparatus 28, 30 may be capable of a degree of lateral motion relative to the track 24, 26. This lateral motion may be permissible because of a low hood clearance that may allow the charging apparatus 28, 30 to extend over a portion of the vehicle 12. In this manner, the lateral motion may permit the end effector 52 to have easier access to the charging receptacle 15 without the need for long extension arms.

Once the charging apparatus 28, 30 is positioned in an appropriate position along the track 24, 26 (step 100) to permit the end effector 52 to move toward the vehicle charging receptacle 15, the robotic controller 56 may then control the one or more joint actuators (step 102) associated with the one or more arm members 54 to position the end effector 52 proximate to the charging receptacle 15. In one embodiment, the positioning of the end effector 52 at step 102 may include refining the position of the charging apparatus 28, 30 along the track.

In order to position the end effector 52 at step 102, the robotic controller 56 may begin by determining the location of the charging receptacle 15 on the vehicle 12 at 104. This may occur via visual identification, by receiving a signal from the vehicle via the communication link, or through a separate transponder or RFID device placed proximate to the charging receptacle 15. In one embodiment, the charging receptacle 15 may be covered by a door or other selectively removable panel. An RFID chip or other transponder may be affixed to the door or placed adjacent to the receptacle 15 to provide an indication of location.

Once the receptacle 15 is located on the vehicle at step 104, the robotic controller 56 may check the spacing of the vehicle 12 relative to any adjacent vehicles at step 106. If the spacing is below allowable tolerances the charging routine may end at step 108, and the user may be notified at step 110. If the clearances are sufficient for the process to continue, the robotic controller 56 may move the end effector 52 to an area proximate to the receptacle 15 at step 112 by controlling one or more joint motors. As the end effector 52 is progressing toward the charging receptacle 15, the robotic controller 56 may continuously monitor sensory feedback for evidence of contact between the arm and a vehicle or other obstruction. If contact is detected, the charging process may abort.

Referring again to FIG. 5, once the end effector 52 is aligned with the charging receptacle 15 at step 66, the robotic controller 56 may couple the end effector 52 with a charging receptacle 15 of the vehicle 12 at step 68. Prior to making such a connection, however, it may be necessary to open a door that covers the receptacle 15. As illustrated in FIG. 8, step 68 may begin by determining if the charging door is open (at 120). If the door is already open, the robotic controller 56 may select the appropriate end effector at step 122, guide the end effector 52 towards the charging receptacle 15 at step 124, and mechanically and/or electrically couple the end effector 52 with the charging receptacle 15 at step 126.

Referring again to FIG. 8, in one configuration the end effector 52 may be guided toward the charging receptacle 15 at step 124 using one or more indicia that may be perceived from the receptacle 15. For example, the end effector 52 may include a sensor that may receive electromagnetic radiation and/or sound pressure waves from the receptacle 15 at step 140, or employing a visual sensor that may receive and process a visual image for aligning and coupling the end effector 52, which is any suitable charge coupler, to the charging receptacle 15. The robotic controller 56 may identify one or more indicia of the charging receptacle 15 from the received radiation/waves at step 142, and may use the positioning of the indicia as feedback during the final approach at step 144. In one configuration, the received electromagnetic radiation may be visible light having a wavelength between 400 nm and 750 nm. Likewise, the sound pressure waves may have a frequency greater than 30 kHz, i.e., ultrasound.

If the charging door is not already open at step 120, then the robotic controller 56 may determine at 128 if the vehicle 12 is equipped with remote door opening capabilities. If so, the robotic controller 56 may send a signal at 130 to instruct the vehicle to open the door, and then may proceed to select the appropriate end effector at 122. If the vehicle is not equipped with remote door opening capabilities, then at 132, the robotic controller 56 may manipulate the end effector 52 to manually open the door by pulling the door open or by pushing the door inward to release a click-lock feature followed by pulling it to a fully open state.

Referring again to FIG. 5, once the end effector 52 is coupled with the charging receptacle 15, the charging controller 34 may charge the vehicle at 70 until the vehicle reports a state of charge (SOC) above a particular threshold. Finally, at 72, the charging controller 34 may instruct the robotic controller 56 to disconnect from the vehicle 12 and return to a home position. The charging controller 34 may monitor the total power provided to the vehicle 12 during the charging step 70, and may subsequently invoice or debit an account of the identified user.

When the robotic controller 56 disconnects from the vehicle 12, the charging routine 60 continues the charging process by identifying the next vehicle in the charging queue and initiating charging thereof (65). The charging routine 60 may continue uninterrupted until all the vehicles 12 parked in the parking spaces 14 serviced by the electric vehicle charging station 10 are charged. However, each occurrence of arrival of a vehicle 12 will re-initiate execution of the charging routine 60 starting at step 61. Likewise, a user may interrupt execution of the charging routine 60 and request that the charging queue be reshuffled.

In addition to the robotic concepts identified above, the presently described electric vehicle charging station 10 may employ any of the vehicle presence detection means, robotic control means, charging receptacle identification means, end effector guidance means, and/or any other concepts that may be disclosed in U.S. patent application Ser. No. 13/484,345 (U.S. Patent Publication No. 2013/0076902), filed on 31 May 2012, and entitled “ROBOTICALLY OPERATED VEHICLE CHARGING STATION,” which is incorporated by reference in its entirety.

FIG. 9 graphically shows an embodiment of a front screen 240 of the human/machine interface device 36 that is described with reference to FIG. 1, which captures user information including charging requests from a user who parked a vehicle 12 in one of the parking spaces 14. The human/machine interface device 36 communicates the user information to the charging controller 34 for charging implementation and to another controller, e.g., the remote server 25 for billing purposes. The human/machine interface device 36 preferably includes a query screen 241, a keyboard 242, data screens including an arrival time screen 243 (“Your Arrival Time”), a requested charge completion time screen 244 (“Charge Done By”), an expected leaving or departure time screen 245 (“Your Expected Leaving Time”) with operator-selectable time entry keys 246 (“H”, “M”, “AM”, “PM”), a charge confirmation key 247 (“OK”), a charge cancellation key 248 (“MANUAL STOP CHARGING”), and a feedback screen 249. The query screen 241 preferably displays a plurality of sequentially presented queries requesting responses from the user that are expected to be completed to facilitate charging. Such queries may include, by way of example, requesting entry of a user identification and password, requesting entry of a parking space numeral or other identifier, requesting entry of an expected departure time, and requesting entry of a requested charging completion time. The user identification may be communicated in the form of a swipe card, a key card, or another suitable mechanism.

In operation, a user inserts a card or employs the keypad to enter the user identification and password, and the employs the keypad to enter the parking space numeral and a present battery level. The system records arrival time. After the system authenticates the user's account, the operator-selectable time entry keys 246 are unlocked to permit entry of expected departure time by the user. The system will display the “expected charge completion time” based on the charging station's current status at the arrival time. The system will display the charge fee (or credit) based on the “Expected Leaving Time” entered by the user. The system may also display the charging station's current status at the time of arrival. The user is able to complete the transaction to have their vehicle charged with the charge confirmation key 247. The user is able to manually stop charging at any time using the charge cancellation key 248.

The charging controller 34 may communicate with a mobile device 20 via the communication device 38, the communications tower 22 and the remote server 25.

FIG. 10 schematically shows one embodiment of the mobile device 20 that communicates with the charging controller 34 via the communication device 38 for capturing user information including charging requests from a user who parked a vehicle 12 in one of the parking spaces 14. The mobile device 20 may be a small, portable computing device having a user interface in the form of a display screen capable of touch inputs and/or a keyboard. The user interface allows a user to interact with the mobile device 20. The user interface may include, but is not limited to, a touch screen, a physical keyboard, a mouse, a microphone, and/or a speaker. In one embodiment, the touch screen is responsive to tactile inputs from a user, including but not limited to pointing, tapping, dragging, two-finger pinching, two-finger expanding, etc. The mobile device 20 preferably includes communications capability in the form of a wireless transceiver capable of executing Wi-Fi, Bluetooth (IEEE 802.11) or other communications schemes. The mobile device 20 may further be equipped with global positioning sensing capabilities and other functions and capabilities. The mobile device 20 preferably includes an operating system that is capable of executing application software programs that are also referred to as apps.

Referring again to FIG. 10, the mobile device 20 may access and execute a vehicle charging application software program, which is referred to herein as a charging app 340. The charging app 340 captures user information including charging requests from a user who parked a vehicle 12 in one of the parking spaces 14, with such user information analogous to the user information captured by the human/machine interface device 36 described with reference to FIG. 9, albeit in a different format or layout. The charging app 340 communicates the user information to the charging controller 34 for charging implementation and to another controller, e.g., the remote server 25 for billing purposes. The charging app 340 preferably includes a query screen 341, a keyboard screen 342, a requested charge completion time screen 344 (“Charge Done By”) and an expected leaving or departure time screen 345 (“Expected Leaving Time”). The keyboard screen 342 is shown with operator-selectable time entry keys related to time in hours and minutes. Other inputs include a charge confirmation key 347 (“Confirm”), a charge cancellation key 348 (“Cancel”), and a feedback screen 349, as well as other information. The query screen 341 may display a plurality of sequentially presented queries requesting responses from the user that are expected to be completed to facilitate charging. Such queries may include, by way of example, requesting entry of a user identification and password, and requesting present battery power level.

In operation, a user accesses the charging app 340 on their mobile device 20 and employs the keypad to enter a password and a vehicle location, i.e., parking space. The system records arrival time. After the system authenticates the user's account, the charging app permits entry of expected departure time by the user using the keyboard screen 342. The system will display the “expected charge completion time” based on the charging station's current status at the arrival time. The system will display the charge fee (or credit) based on the “Expected Leaving Time” entered by the user. The system may also display the charging station's current status at the time of arrival. The user is able to complete the transaction to have their vehicle charged with the charge confirmation key 347. The user is able to manually stop charging at any time using the charge cancellation key 348. If the battery charging cannot be completed by the user-entered “Expected Leaving Time”, then the “Charge Done By” time will not be changed and the feedback screen 349 will show a message such as “sorry, your battery charge cannot be done by your new leaving time.” The “Expected Charge Completion Time” will be automatically changed once use confirms a different “Expected Leaving Time” and the system will display the charge fee (or credit) on the feedback screen 349 based on the “Expected Leaving Time” the user entered.

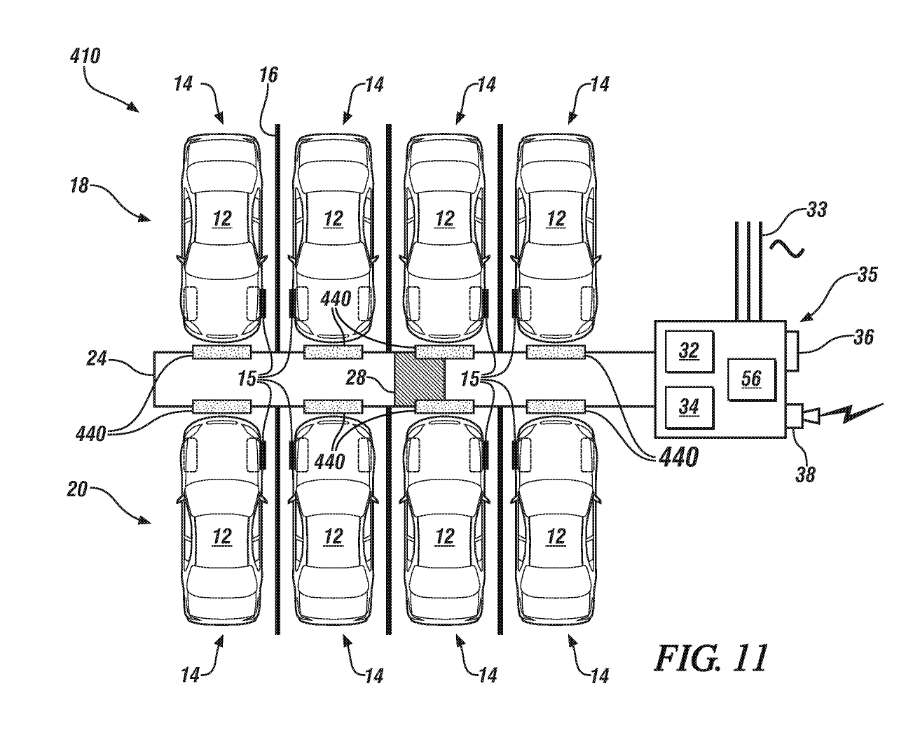

FIG. 11 schematically illustrates another embodiment of an electric vehicle charging station 410 that is capable of servicing the parking spaces 14 for charging a primary energy storage device of each of a plurality of electric vehicles 12 that are parked therein. The electric vehicle charging station 410 described herein is provided for purposes of illustration; the concepts described herein may be employed on various configurations of electric vehicle charging stations that provide charging service for a plurality of parking spaces 14 for charging a primary energy storage device for a plurality of electric vehicles 12. The electric vehicle charging station 410 may be a stationary apparatus that may be disposed in a parking lot or other vehicle storage area that includes a plurality of parking spaces 14, e.g., parking garage, valet parking area, fleet vehicle storage area, etc. The recharging area includes eight parking spaces 14, organized into two rows 18, 20 of four spaces 14 each. The charging station 10 may include track 24 that extends across a plurality of the parking spaces 14 (e.g., along each row 18, 20), and allows the movable charging apparatus 28 to access each vehicle 12 to facilitate selective recharging of the vehicle's battery. The charging apparatus 28 may be electrically and communicatively coupled with an automatic charging station including a power supply circuit 32, a charging controller 34, a robotic controller 56 and a plurality of human/machine interface devices 440, e.g., a graphic user interface or touchpad. The human/machine interface devices 440 each service one of the parking spaces 14 accessible to and serviced by the movable charging apparatus 28 in this embodiment. The human/machine interface devices 440 communicate user inputs in the form of charging requests to the charging controller 34. The automatic charging station 35 may further include a communication device 38 that is capable of communicating with the remote server 25 as described with reference to FIG. 1.

Referring again to FIGS. 1, 2 and 11, in operation the charge controller 34 determines a preferred charging sequence for all the vehicles 12 that are parked in the parking spaces 14 serviced by the electric vehicle charging station 10, 410, including any newly arrived vehicle that has been identified. The preferred charging sequence may be in the form of a charging queue that identifies each of the vehicles 12 and its place in the queue. Determining the preferred charging sequence for all the vehicles that are parked in the parking spaces 14 serviced by the electric vehicle charging station 10 may include determining states for input parameters for each of the vehicles 12 that are parked in the parking spaces 14, including a vehicle arrival time, a remaining power level for the vehicle battery, a total electric power capacity of the vehicle battery, a period of time required to achieve a target charge level for the vehicle battery, an average parking time, an expected departure time, and credit points, if any. The remaining power level for the vehicle battery may be in any suitable value, and is often reported as a percentage of battery state of charge (SOC). The total electric power capacity of the vehicle battery may be expressed in terms of kilowatt-hours. The period of time required to achieve a target charge level for the vehicle battery may be calculated or otherwise determined, with the target charge level expressed in terms of a full charge or a target charge level, e.g., 85% SOC. The average parking time may be calculated based upon historical data for each vehicle. The expected departure time may be based upon historical data or user input. The credit points may be defined by a service provider, and may relate to fee payments and other factors.

The plurality of vehicles parked in the parking spaces 14 are charged employing the movable charging apparatus 30 based upon the preferred charging sequence. When the preferred charging sequence has been determined, the next vehicle in the charging queue is identified, the charging controller 34 may instruct the robotic controller 56 to move the charging apparatus 28 to the vehicle requiring charging and couple the end effector 52 with the charging receptacle 15 of the vehicle 12. Once coupled, the charging controller 34 may charge the vehicle until the vehicle reports a state of charge (SOC) above a particular threshold.

The vehicle charging station 10 may provide a conditioned supply of electrical power to a vehicle 12 from a power source such as an external electrical grid or a large number of solar cells. To accomplish this, the charging station 10 may include a power delivery circuit 32 that receives either one or three phase AC electrical power 33, and is configured to output either direct current (DC) electrical power, or alternating current (AC) electrical power. Depending on the nature of the external power supply, the power delivery circuit 32 may include an inverter/converter to provide the vehicle with the properly conditioned, rectified, and/or filtered AC or DC power supply.

In one configuration, the power delivery circuit 32 may output an electrical charge that has a voltage in the range of 200-500 VAC or 400-500 VDC, and a total power less than approximately 50 kW. Such a system requires considerably lower power capabilities than a comparable charging station that utilizes dedicated charging terminals at each parking space 14. For example, the present system 10 may draw 50 kW for eight parking spaces, whereas eight dedicated terminals may draw a collective 400 kW. In another configuration, multiple movable charging apparatuses 28 may be disposed on a respective track 24. In this manner, the two apparatuses may divide the charging duties to avoid large charging queues, though may employ a single track, albeit requiring a power circuit 32 with twice the power capacity. In another configuration, multiple charging stations 10 may be arranged in an adjacent fashion to provide for easy scalability. In this configuration, each charging station 10 may include its own dedicated movable charging apparatus 28, 30. In another configuration, the various movable charging apparatuses 28, 30 may be freely translatable between adjacent tracks to facilitate greater flexibility and scalability.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A multi-user electric vehicle charging station, comprising:
a movable charging apparatus that is disposed to service a plurality of parking spaces;
a controller operatively connected to the movable charging apparatus;
a human/machine interface device in communication with the controller, the human/machine interface device including user-selectable states including a user identification, identification of a specific one of the parking spaces, a present battery level, and an expected departure time associated with a vehicle parked in the specific one of the parking spaces.

2. The multi-user electric vehicle charging station of claim 1, wherein the controller includes a wireless communications transceiver; and wherein the human/machine interface device comprises a remotely located mobile device employing wireless communications and a mobile software application.

3. The multi-user electric vehicle charging station of claim 1, wherein the movable charging apparatus is disposed to translate on a track that extends across the plurality of parking spaces.

4. The multi-user electric vehicle charging station of claim 3, wherein the track comprises a ground-level track.

5. The multi-user electric vehicle charging station of claim 3, wherein the track comprises an overhead track.

6. The multi-user electric vehicle charging station of claim 1, further comprising a communication device capable of communicating with a remote server.

7. The multi-user electric vehicle charging station of claim 1, wherein the movable charging apparatus disposed to service a plurality of parking spaces

8. The multi-user electric vehicle charging station of claim 1, wherein the movable charging apparatus include an end-effector that is disposed to service the plurality of parking spaces.

9. The multi-user electric vehicle charging station of claim 8, wherein the end effector is in mechanical communication with a base through a plurality of rigid arm members.

10. The multi-user electric vehicle charging station of claim 8, wherein the end effector is in mechanical communication with a base through a flexible electrical cable.

11. The multi-user electric vehicle charging station of claim 8, wherein the end effector is manually positioned to charge a vehicle.

12. The multi-user electric vehicle charging station of claim 8, wherein the end effector is automatically positioned to charge a vehicle.

13. The multi-user electric vehicle charging station of claim 1, wherein the movable charging apparatus is electrically connected to a power delivery circuit.

14. The multi-user electric vehicle charging station of claim 13, wherein the power delivery circuit is configured to receive either one- or three-phase AC electrical power.

15. The multi-user electric vehicle charging station of claim 13, wherein the power delivery circuit is configured to output a direct current (DC) electrical power.

16. The multi-user electric vehicle charging station of claim 13, wherein the power delivery circuit is configured to output an alternating current (AC) electrical power.

17. A method for controlling operation of a movable charging apparatus of an electric vehicle charging station that is disposed to service vehicles in a plurality of parking spaces, the method comprising:
upon entry of a vehicle into one of the vehicle parking spaces accompanied with a charging request for a vehicle battery:
determining, for each of a plurality of vehicles parked in the parking spaces, states for input parameters for each of the vehicles;
determining, by a controller, a preferred charging sequence for the plurality of vehicles parked in the parking spaces based upon the states for input parameters for each of the vehicles, and
sequentially charging the plurality of vehicles parked in the parking spaces employing the movable charging apparatus based upon the preferred charging sequence.

18. The method of claim 17, wherein determining states for input parameters for each of the vehicles comprises determining a vehicle arrival time, a remaining power level for a vehicle battery, a total electric power capacity of the vehicle battery, a period of time required to achieve a target charge level for the vehicle battery, an average parking time, an expected departure time, and credit points.

19. The method of claim 17, wherein the preferred charging sequence comprises a charging queue that identifies each of the vehicles and its place in the queue.

20. A method for controlling operation of a movable charging apparatus of an electric vehicle charging station that is disposed to service vehicles in a plurality of parking spaces, the method comprising:
upon entry of a vehicle into one of the vehicle parking spaces accompanied with a charging request for a vehicle battery:
determining, for each of a plurality of vehicles parked in the parking spaces, a vehicle arrival time, a remaining power level for the vehicle battery, and an expected departure time,
determining, by a controller, a preferred charging sequence for the plurality of vehicles parked in the parking spaces based upon the corresponding vehicle arrival times, the remaining power levels for the vehicle batteries and the expected departure times, and
sequentially charging the plurality of vehicles parked in the parking spaces employing the movable charging apparatus based upon the preferred charging sequence.
